(19) United States
(12) Patent Application Publication
(10) Pub. No.: US 2026/0208683 A1
(43) Pub. Date: Jul. 23, 2026

(54) IN-VEHICLE DEVICE AND IN-VEHICLE SYSTEM

(71) Applicant: DENSO CORPORATION, Kariya-shi (JP)

(72) Inventors: Tetsuo NAKAGAWA, Kariya-shi (JP); Tomohisa KISHIGAMI, Kariya-shi (JP)

(21) Appl. No.: 19/447,861

(22) Filed: Jan. 13, 2026

(30) Foreign Application Priority Data
Jan. 17, 2025 (JP) 2025-006959

(51) Int. Cl. B60R 16/03; B60R 16/023

(52) U.S. Cl. CPC B60R 16/03; B60R 16/023

(57) ABSTRACT

An in-vehicle device used in an in-vehicle system in which a plurality of communication devices are installed is provided. Each of the plurality of communication devices is configured to receive power supply via each power supply path, and each of the power supply paths is provided with a power supply switching unit. The in-vehicle device is configured to execute switching control, and communicate with the plurality of communication devices. The in-vehicle device determines that the power supply switching unit is in an interruption failure state. The in-vehicle device is configured to transmit a stop frame, which is a communication frame instructing the communication device corresponding to the one of the power supply switching units to stop the transmission process.

### CROSS REFERENCE TO RELATED APPLICATION

This application is based on Japanese Patent Application No. 2025-006959 filed on Jan. 17, 2025, the disclosure of which is incorporated herein by reference.

### TECHNICAL FIELD

The present disclosure relates to an in-vehicle device and an in-vehicle system.

### BACKGROUND

A related art describes an in-vehicle system including a power supply device and a plurality of communication devices. The power supply device and each communication device are connected via power supply lines that extend from the power supply device and branch according to the number of communication devices. On each branched power supply line, a power supply interruption unit corresponding to each communication device is provided. The power supply interruption unit interrupts the power supply from the power supply device to the communication device. According to the in-vehicle system, since the power supply is interrupted for each communication device, the system selectively interrupts the power supply only to communication devices for which communication is unnecessary.

### SUMMARY

According to an aspect of the present disclosure, an in-vehicle device used in an in-vehicle system in which a plurality of communication devices are installed is provided. Each of the plurality of communication devices is configured to receive power supply via each power supply path, and each of the power supply paths is provided with a power supply switching unit configured to switch between an ON state in which the respective power supply path is conducted and an OFF state in which the respective power supply path is interrupted. The in-vehicle device includes at least one of (i) a circuit and (ii) a processor with a memory storing computer program code executable by the processor, the at least one of the circuit and the processor configured to cause the in-vehicle device to: execute switching control to switch the power supply switching unit to either the ON state or the OFF state; and communicate with the plurality of communication devices. For each of the power supply switching units, when the in-vehicle device receives a communication frame from a communication device corresponding to the power supply switching unit for which switching control to the OFF state has been executed, the in-vehicle device may determine that the power supply switching unit is in an interruption failure state in which the power supply switching unit cannot transition to the OFF state. When switching control to transition one of the power supply switching units to the OFF state is executed, and when the one of the power supply switching units is determined to be in the interruption failure state, the in-vehicle device may transmit a stop frame, which is a communication frame instructing the communication device corresponding to the one of the power supply switching units to stop the transmission process for transmitting a communication frame.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing the configuration of the communication system according to the embodiment;

FIG. 2 is a block diagram of the electronic control unit;

FIG. 3A is a diagram for explaining an example of management information,

FIG. 3B is a diagram for explaining an example of switching control;

FIG. 4A is an example of a list associating the power supply switching unit and the connected ECU,

FIG. 4B is an example of a stop frame and a start frame;

FIG. 5 is a sequence diagram showing the process of switching to the OFF state during a stuck-ON fault;

FIG. 6 is a sequence diagram showing the process of switching to the ON state during a stuck-ON fault;

FIG. 7 is a flowchart showing the process when executing switching control;

FIG. 8 is a flowchart showing the process when stopping or starting the transmission process;

FIG. 9 is a block diagram showing the configuration of the communication system according to Modification Example 1;

FIG. 10 is a block diagram showing the configuration of the communication system according to Modification Example 2; and

FIG. 11 is a block diagram showing the configuration of the communication system according to Modification Example 3.

### DETAILED DESCRIPTION

However, as a result of detailed investigation by the inventors, the following issues have been identified. Namely, if the power supply interruption unit fails, it may not be possible to interrupt the power supply. Even if a communication device is in a situation where communication is originally unnecessary, if the power supply is not interrupted, the communication device may perform unnecessary communication.

The present disclosure provides a technology whereby, even if the power supply to a communication device is not interrupted, the communication device does not perform unnecessary communication.

According to one aspect of the present disclosure, an in-vehicle device used in an in-vehicle system in which a plurality of communication devices are installed is provided. Each of the plurality of communication devices is configured to receive power supply via each power supply path, and each of the power supply paths is provided with a power supply switching unit configured to switch between an ON state in which the respective power supply path is conducted and an OFF state in which the respective power supply path is interrupted. The in-vehicle device includes: a control unit configured to execute switching control to switch the power supply switching unit to either the ON state or the OFF state; and a communication unit configured to communicate with the plurality of communication devices. For each of the power supply switching units, when the control unit receives a communication frame from a communication device corresponding to the power supply switching unit for which switching control to the OFF state has been executed, the control unit determines that the power supply switching unit is in an interruption failure state in which the power supply switching unit cannot transition to the OFF state. When switching control to transition one of the power supply switching units to the OFF state is executed by the control unit, and when the one of the power supply switching units is determined to be in the interruption failure state by the control unit, the communication unit transmits a stop frame, which is a communication frame instructing the communication device corresponding to the one of the power supply switching units to stop the transmission process for transmitting a communication frame.

According to such a configuration, even if the power supply path is not actually interrupted, the plurality of communication devices can recognize that it is a situation in which the transmission process should originally be stopped. Therefore, the plurality of communication devices can stop the transmission process by simulating the situation where the power supply switching unit has actually switched to the OFF state. Accordingly, even if the power supply to the plurality of communication devices is not interrupted, the plurality of communication devices will not perform unnecessary communication.

An embodiment of the present disclosure may also be an in-vehicle system in which a plurality of communication devices and an in-vehicle device are installed.

Hereinafter, exemplary embodiments of the present disclosure will be described with reference to the drawings.

### 1. Embodiment)

### 1-1. Configuration

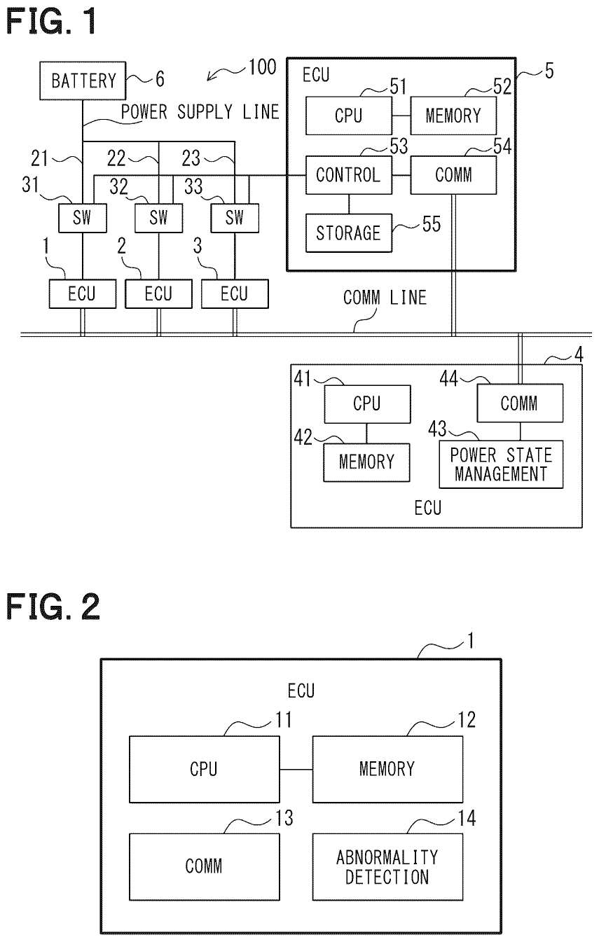

The communication system 100 shown in FIG. 1 is a network system installed in a vehicle, such as a passenger car. The communication system 100 is an in-vehicle system in which a plurality of electronic control units (hereinafter, ECUs 1-5) are installed. The communication system 100 is an in-vehicle system equipped with a plurality of electronic control units. The plurality of ECUs 1-5 are connected to each other via communication lines so as to be capable of data communication. ECU stands for “Electronic Control Unit.”

ECUs 1-5 receive power supply from a battery 6 installed in the vehicle via power supply lines. The battery 6 supplies power at a DC battery voltage (for example, 12V). The power supply lines branch from the battery 6 and are extended to form power supply paths 21-23. In this embodiment, ECU 1 receives power supply from the battery 6 via the power supply path 21 between the battery 6 and ECU 1. ECU 2 receives power supply from the battery 6 via the power supply path 22 between the battery 6 and ECU 2. ECU 3 receives power supply from the battery 6 via the power supply path 23 between the battery 6 and ECU 3. Although the power supply paths for ECU 4 and ECU 5 are omitted in the drawings, ECU 4 and ECU 5 also receive power supply from the battery 6.

ECUs 1-5 are configured to be capable of transitioning between a wake-up state, which is a normal operating state, and a sleep state, which is a low power consumption operating state in which at least a part of their functions are restricted. For example, in the wake-up state, ECUs 1-5 can use all of their functions. On the other hand, in the sleep state, functions other than the reception process described later may be restricted. ECUs 1-5 transition from the wake-up state to the sleep state when no ECUs receives a communication request. In other words, ECUs 1-5 transition to the sleep state if no communication request is received from any ECU for a predetermined period of time. Conversely, ECUs 1-5 maintain the wake-up state when a communication request is received from any ECU.

For example, when power supply from the battery 6 to each ECU 1-5 is interrupted, each ECU 1-5 stops transmitting communication requests and transitions to the sleep state. That is, when all ECUs 1-5 constituting the communication system 100 stop transmitting communication requests, none of the ECUs 1-5 receives communication requests, and the entire communication system 100 transitions to a low power consumption state. The communication request indicates a request to transmit a communication frame.

Power supply paths 21-23 are each provided with a power supply switching unit 31-33. The power supply switching units 31-33 are configured to switch between an ON state, in which each power supply path is conducted, and an OFF state, in which each power supply path is interrupted. The power supply switching units 31-33 are constituted, for example, by mechanical relays having mechanical contacts, or by semiconductor relays without mechanical contacts. In this embodiment, the power supply switching units 31-33 are implemented using semiconductor relays, such as FETs. The control unit 53, described later, applies a gate voltage to the gate terminal of the FET, thereby switching the FET to the ON state. Note that the power supply switching units 31-33 may also be illustrated as SW31-33 in the drawings.

As shown in FIG. 2, ECU 1 is equipped with a CPU 11 and a memory 12. The memory 12 stores a program for the CPU 11 to execute predetermined functions. ECU 1 realizes the functions of the following units by the CPU 11 executing the program stored in the memory 12. That is, ECU 1 has the functions of a communication unit 13 and an anomaly detection unit 14, which is described as ABNORMALITY DETECTION in the drawings.

The communication unit 13 is configured to be capable of communicating with ECUs 2-5. More specifically, the communication unit 13 executes a transmission process for transmitting communication frames and a reception process for receiving communication frames. The communication unit 13 is configured to be capable of receiving the stop frame and start frame described later. The communication unit 13 is configured to receive not only stop frames and start frames addressed to itself, but also stop frames and start frames addressed to other ECUs.

The anomaly detection unit 14 is configured to execute communication anomaly detection (hereinafter also referred to as anomaly detection process) to determine whether there is an anomaly in the communication state of the communication system 100. For example, as communication anomaly detection, the anomaly detection unit 14 executes disconnection determination to determine whether communication frames that should be received from other ECUs have been interrupted. More specifically, if the state in which communication frames transmitted from other ECUs are not received continues for a preset communication anomaly determination time (for example, 2 seconds), the anomaly detection unit 14 determines that a communication anomaly has occurred with another ECU and that there is an anomaly in the communication state of the communication system.

When ECU 1 receives a stop frame, it stops the transmission process by the communication unit 13 and also stops the above-mentioned communication anomaly detection by the anomaly detection unit 14. On the other hand, when ECU 1 receives a start frame, it starts the transmission process by the communication unit 13 and also starts the above-mentioned communication anomaly detection by the anomaly detection unit 14.

Although block diagrams of ECUs 2 and 3 are omitted, ECUs 2 and 3 have the same configuration as ECU 1. Returning to FIG. 1, ECU 4 is equipped with a CPU 41 and a memory 42. The memory 42 stores a program for the CPU 41 to execute predetermined functions.

By executing the program stored in the memory 42, ECU 4 realizes the functions of the following units. That is, ECU 4 has the functions of a power state management unit 43 and a communication unit 44.

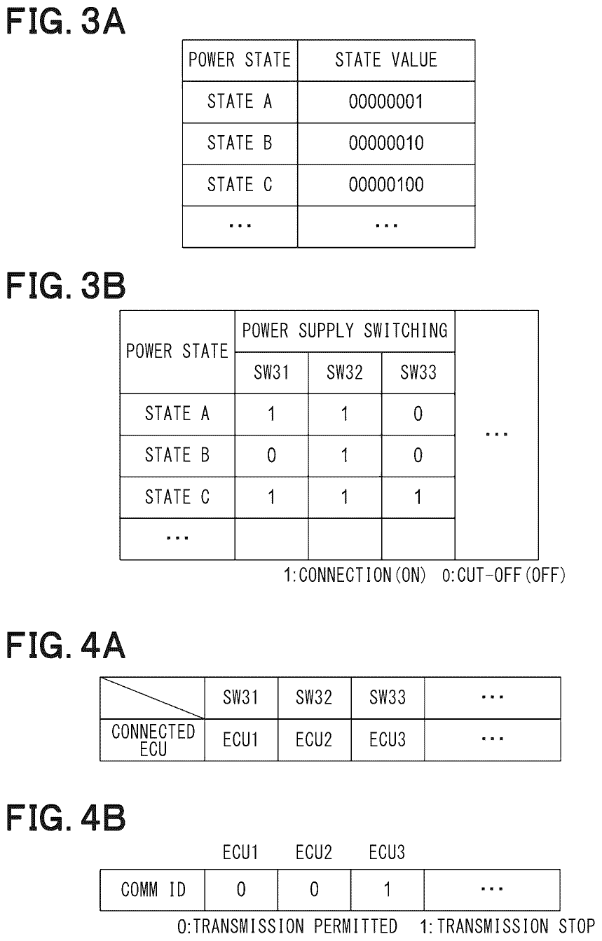

The power state management unit 43 is configured to manage whether each power supply switching unit 31-33 should transition to the ON state or the OFF state according to the running state of the vehicle. As one example, as shown in FIG. 3A, the power state management unit 43 classifies power states in advance and manages them as management information. Management information refers to information indicating whether the power supply switching units 31-33 should transition to the ON state or the OFF state. For example, State A is a predefined rule indicating that ECU 1 and ECU 2 are supplied with power, while ECU 3 is not. In other words, State A indicates that power supply switching units 31 and 32 should transition to the ON state, but power supply switching unit 33 should transition to the OFF state.

Further, for example, State B is a rule that is set in advance to indicate a state in which ECU 2 is supplied with power, but ECU 1 and ECU 3 are not. In other words, State B indicates that power supply switching unit 32 should transition to the ON state, but power supply switching units 31 and 33 should transition to the OFF state. Further, for example, State C is a rule that is set in advance to indicate that ECUs 1-3 are supplied with power. In other words, State C indicates that power supply switching units 31-33 should transition to the ON state.

For example, the power state management unit 43 manages the relationship between the running state of the vehicle and the state. When the running state changes from cruise control execution to cruise control cancellation, the state should be changed from State B to State C.

The communication unit 44 is configured to be capable of communicating with ECUs 1-3 and 5. The power state management unit 43 notifies the control unit 53 of ECU 5 of the management information via the communication unit 44. ECU 5 is equipped with a CPU 51 and a memory 52. The memory 52 stores a program that enables the CPU 51 to execute predetermined functions.

By executing the program stored in the memory 52, ECU 5 realizes the functions of the following units. That is, ECU 5 has the functions of a control unit 53, a communication unit 54, and a memory unit 55, which is descried as “STORAGE” in the drawings.

The control unit 53 is configured to execute switching control to switch the power supply switching units 31-33 to either the ON state or the OFF state. That is, the control unit 53 executes switching control to set the power supply switching units 31-33 to the ON or OFF state. The control unit 53 executes switching control in accordance with the management information notified from the power state management unit 43. As shown in FIG. 3B, an example will be described in which State A is notified as management information. In the case of State A, a rule is set in advance such that the power supply switching units 31 and 32 are switched to the ON state, and the power supply switching unit 33 is switched to the OFF state. The control unit 53 applies gate voltage to the gate terminals of the power supply switching units 31 and 32. On the other hand, the control unit 53 stops applying gate voltage to the gate terminal of the power supply switching unit 33.

Similarly, when State B is notified, a rule is set such that the power supply switching unit 32 is switched to the ON state, and the power supply switching units 31 and 33 are switched to the OFF state. When State C is notified, a rule is set such that the power supply switching units 31, 32, and 33 are switched to the ON state. The control unit 53 executes switching control according to the type of state notified from the power state management unit 43.

Here, even if the control unit 53 stops applying gate voltage to the gate terminal, an abnormality (hereinafter also referred to as stuck-ON fault) may occur in which the power supply switching unit does not switch to the OFF state and remains in the ON state.

The control unit 53 is also configured to determine whether the power supply switching units 31-33 are in an interruption failure state (also referred to as a switching failure state or a disconnection failure state) in which they cannot transition to the OFF state. More specifically, the control unit 53 is configured to determine whether a stuck-ON fault has occurred in the power supply switching units 31-33. Specifically, for each of the power supply switching units 31-33, when switching control is executed to transition to the OFF state and a communication frame is received from the corresponding ECUs 1-3, the control unit 53 determines that the power supply switching unit is in an interruption failure state. In other words, if a communication frame is received from the corresponding ECUs 1-3 after switching control has been executed to transition to the OFF state, the control unit 53 determines that a stuck-ON fault has occurred in the power supply switching unit.

Normally, when the power supply switching units 31-33 transition to the OFF state, power supply to the corresponding ECUs 1-3 is interrupted, so the transmission process should also be stopped. Therefore, no communication frames should be transmitted from ECUs 1-3. Nevertheless, if a communication frame is received from ECUs 1-3, it can be considered that a stuck-ON fault has occurred in the power supply switching units 31-33, and that the power supply to ECUs 1-3 cannot be interrupted.

The control unit 53 retains information associating the power supply switching units and the ECUs corresponding to the power supply switching units (hereinafter also referred to as connected ECUs). For example, as shown in FIG. 4A, the control unit 53 retains a list linking the power supply switching units to the connected ECUs.

Further, the control unit 53 instructs the communication unit 54 to transmit stop frames and start frames. More specifically, when switching control is executed by the control unit 53 to transition any one of the power supply switching units 31-33 to the OFF state, and it is determined that the relevant power supply switching unit is in an interruption failure state, the control unit 53 instructs the communication unit 54 to transmit a stop frame. The stop frame is a communication frame that instructs the ECU corresponding to the power supply switching unit to stop the transmission process for transmitting communication frames.

Additionally, when switching control is executed by the control unit 53 to transition any one of the power supply switching units 31-33 to the ON state, and it is determined that the power supply switching unit is in an interruption failure state, the control unit 53 instructs the communication unit 54 to transmit a start frame. The start frame is a communication frame that instructs the ECU corresponding to the relevant power supply switching unit to start the transmission process for transmitting communication frames.

As one example, as shown in FIG. 4B, a communication frame representing a transmission process instruction signal is used as the stop frame and start frame. The transmission process instruction signal is a signal indicating either an instruction to stop transmission or an instruction to permit (or allow) transmission, where “1” indicates an instruction to stop transmission and “0” indicates an instruction to permit transmission. For example, the most significant bit (MSB) of the data field is associated with ECU 1, the second bit with ECU 2, and the third bit with ECU 3. In other words, the first upper bit of the data field is associated with ECU 1, the second upper bit is associated with ECU 2, and the third upper bit is associated with ECU 3.

For example, different communication frames may be used as the stop frame and start frame for each ECU, respectively. Further, the stop frame and the start frame may be transmitted as separate communication frames.

The communication unit 54 is configured to be capable of communicating with ECUs 1-4. The communication unit 54 transmits stop frames and start frames in accordance with instructions from the control unit 53. In other words, when switching control is executed by the control unit 53 to transition one of the power supply switching units to the OFF state, and it is determined by the control unit 53 that the power supply switching unit is in an interruption failure state, the communication unit 54 transmits a stop frame. Conversely, when switching control is executed by the control unit 53 to transition one of the power supply switching units to the ON state, and it is determined by the control unit 53 that the power supply switching unit is in an interruption failure state, the communication unit 54 transmits a start frame.

The memory unit 55 stores at least the fault location. More specifically, the memory unit 55 stores the power supply switching unit determined to be in an interruption failure state by the control unit 53 and the ECU connected to the power supply switching unit.

### 1-2. Process

### 1-2-1. Switching to OFF State During Stuck-ON Fault

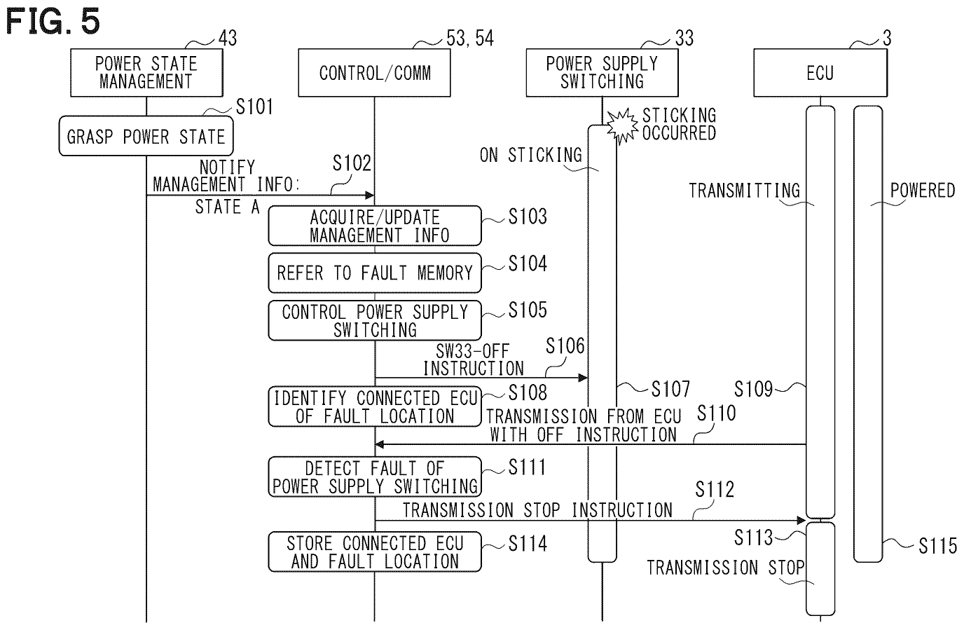

The process executed in the communication system 100 (hereinafter referred to as switching process) will be described. First, using the sequence diagram in FIG. 5, an overview of the switching to the OFF state during a stuck-ON fault will be explained. In this sequence diagram, it is assumed that a stuck-ON fault has occurred in the power supply switching unit 33. This switching process is repeatedly executed at a predetermined cycle during the operation of the power state management unit 43. This switching process may also be executed each time the running state of the vehicle changes and a situation arises in which the power state should be changed.

In S101, the power state management unit 43 acquires the power state. More specifically, the power state management unit 43 determines, according to the running state of the vehicle, to which state it should transition. For example, the power state management unit 43 determines that it should transition to State A.

In S102, the power state management unit 43 notifies the control unit 53 of the management information. For example, the power state management unit 43 notifies the control unit 53 of State A determined in S201.

Subsequently, in S103, the control unit 53 acquires the management information. In addition, since the control unit 53 retains the management information previously notified from the power state management unit 43, when new management information is notified, the retained management information is updated.

In S104, the control unit 53 refers to the fault memory. More specifically, the control unit 53 checks whether the fault location is stored in the memory unit 55. Subsequently, in S105, the control unit 53 executes switching control in accordance with the management information. More specifically, the control unit 53 executes switching control for each power supply switching unit 31-33 according to the value of the state. For example, the control unit 53 executes switching control for each power supply switching unit 31-33 according to the value of State A.

In S106, the control unit 53 executes switching to the OFF state for the power supply switching unit 33. However, as in S107, the power supply switching unit 33 is in a stuck-ON fault state, which may be referred to as on-sticking state. Therefore, the power supply path 23 is not interrupted, and as in S115, ECU 3 remains powered. Normally, when the power supply to ECU 3 is stopped, the transmission process should also stop. However, since ECU 3 remains powered, as in S109, ECU 3 continues the transmission process.

In S108, the control unit 53 identifies the ECU connected to the faulty power supply switching unit (the fault location). More specifically, the control unit 53 checks which ECU is associated with the fault location stored in the memory unit 55.

In S110, the communication unit 54 receives a communication frame from ECU 3. In S111, the control unit 53 determines that the power supply switching unit 33 is in an interruption failure state. For example, if ECU 3 associated with the fault location is not stored in the memory unit 55, the control unit 53 detects that the power supply switching unit 33 has newly failed (that is, a stuck-ON fault has occurred in the power supply switching unit 33).

In S112, the communication unit 54 transmits a stop frame. Specifically, the communication unit 54 instructs ECU 3 to stop the transmission process. Since ECU 3 has received a stop frame addressed to itself, as in S113, it stops the transmission process. That is, even though ECU 3 remains powered, it stops the transmission process. As a result, the transmission process, which should have been stopped when the power supply to ECU 3 was stopped, is stopped. ECU 3 does not stop the reception process. As will be described in detail later, there may be cases where the transmission process is resumed upon receiving a start frame.

In S114, the control unit 53 records the newly failed power supply switching unit and the connected ECU in the memory unit 55. Specifically, if the power supply switching unit 33 and ECU 3 are not stored in the memory unit 55 as the fault location and the connected ECU associated with the fault location, the control unit 53 newly stores the power supply switching unit 33 and ECU 3 in the memory unit 55.

### 1-2-2. Switching to ON State During Stuck-ON Fault

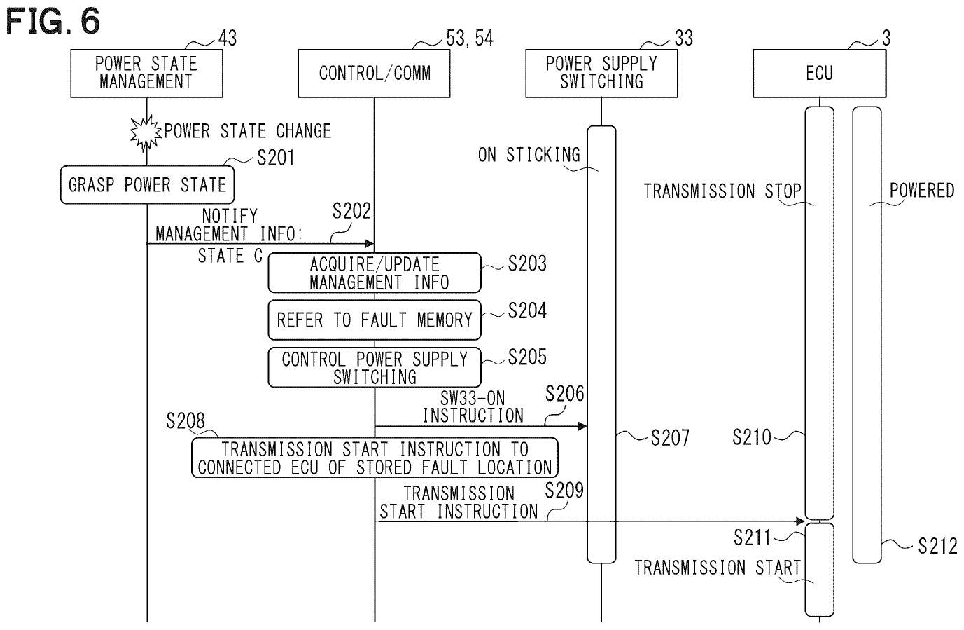

An overview of the process of switching to the ON state during a stuck-ON fault will be explained using the sequence diagram in FIG. 6. In this sequence diagram, it is assumed that a stuck-ON fault has occurred in the power supply switching unit 33. Furthermore, it is assumed that the states corresponding to S112 and S113 in the sequence diagram of FIG. 5 have already been executed. That is, a stuck-ON fault has occurred in the power supply switching unit 33, the power supply path 23 is not interrupted, ECU 3 remains powered, but the transmission process is stopped.

When the running state of the vehicle changes and a situation arises in which the power state should be changed, in S201, the power state management unit 43 acquires the new power state. For example, the power state management unit 43 determines that it should transition to State C.

In S202, the power state management unit 43 notifies the control unit 53 of the management information. For example, the power state management unit 43 notifies the control unit 53 of State C determined in S201. Subsequently, in S203, the control unit 53 acquires the management information. The control unit 53 also updates the currently retained management information to the new management information.

In S204, the control unit 53 checks the fault memory. It is assumed that the memory unit 55 stores the power supply switching unit 33 and ECU 3 as the fault location and the connected ECU associated with the fault location.

Subsequently, in S205, the control unit 53 executes switching control in accordance with the management information. Specifically, the control unit 53 executes switching control for each power supply switching unit 31-33 according to the value of State C.

In S206, the control unit 53 executes switching to the ON state for the power supply switching unit 33. Here, in S207, the power supply switching unit 33 remains in the stuck-ON fault state. Therefore, the power supply path 23 is not interrupted, and in S212, ECU 3 remains powered. Normally, when the power supply to ECU 3 transitions from stopped to started, the transmission process should also resume. However, as described above, ECU 3 remains powered but the transmission process is stopped (S210).

When the control unit 53 executes switching to the ON state for the power supply switching unit corresponding to the ECU stored in the memory unit 55, in S208, the control unit 53 instructs the communication unit 54 to transmit a start frame to the ECU stored in the memory unit 55. Specifically, since the power supply switching unit 33 and ECU 3 are stored in the memory unit 55, the control unit 53 instructs the communication unit 54 to transmit a start frame to ECU 3.

In S209, the communication unit 54 transmits a start frame. Specifically, the communication unit 54 instructs ECU 3 to start the transmission process. Since ECU 3 has received a start frame addressed to itself, as in S211, it starts the transmission process. As a result, the transmission process, which should have been started when the power supply to ECU 3 was started, is started.

### 1-2-3. Processing When Executing Switching Control

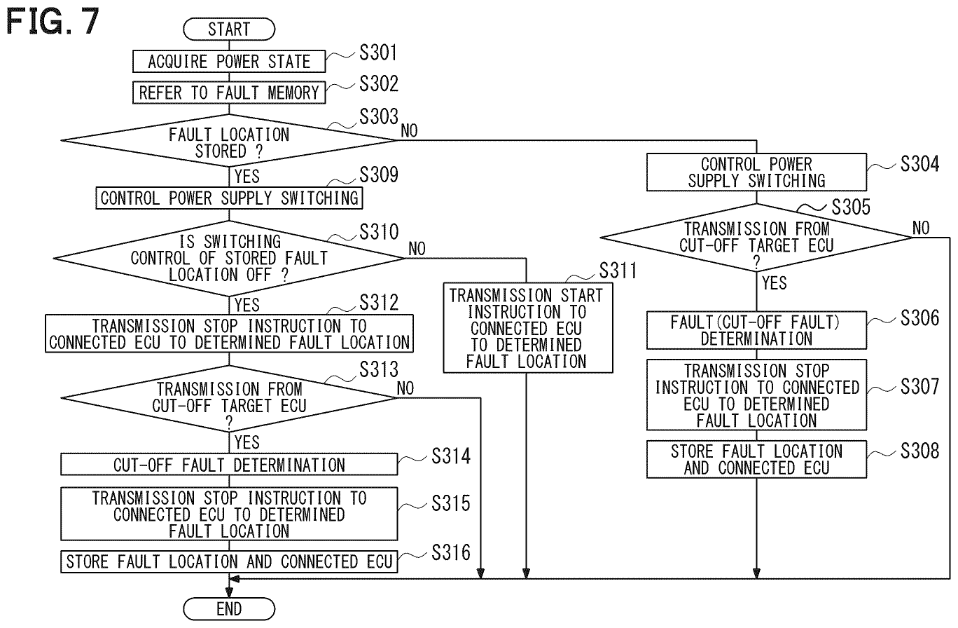

The process executed by ECU 5 when performing switching control will be explained with reference to the flowchart in FIG. 7. This process is executed each time management information is notified from the power state management unit 43.

In S301, the control unit 53 obtains the power state. Specifically, the control unit 53 acquires management information from the power state management unit 43 via the communication unit 54. In S302, the control unit 53 checks the fault memory.

Subsequently, in S303, the control unit 53 determines whether the fault location is stored. If the control unit 53 determines in S303 that no information is stored regarding the fault location, it proceeds to S304. In other words, if no stuck-ON fault has occurred in any of the power supply switching units 31-33 when this process was last executed, the control unit 53 proceeds to S304.

In S304, the control unit 53 executes switching control for the power supply switching units 31-33. In S305, the control unit 53 determines whether a communication frame has been transmitted from the ECUs 1-3 corresponding to the power supply switching units for which switching control to the OFF state was executed (hereinafter referred to as disconnection target ECUs).

If the control unit 53 determines in S305 that no communication frame has been transmitted from the disconnection target ECUs, this switching process is terminated. The fact that no communication frame was received from the disconnection target ECUs is considered to mean that the transmission process of the disconnection target ECUs has been stopped. That is, it is considered that no stuck-ON fault has occurred in the power supply switching units corresponding to the disconnection target ECUs, and that the switching to the OFF state was performed normally.

On the other hand, if the control unit 53 determines in S305 that a communication frame has been transmitted from the disconnection target ECUs, it proceeds to S306 and determines that the power supply switching unit corresponding to the disconnection target ECU is in an interruption failure state, which may be referred to as cut-off fault state. The fact that a communication frame was received from the disconnection target ECU is considered to mean that a stuck-ON fault has occurred in the power supply switching unit corresponding to the disconnection target ECU, and that the power supply to the disconnection target ECU cannot be interrupted.

In S307, the communication unit 54 transmits a stop frame to the disconnection target ECU. In S308, the control unit 53 stores the power supply switching unit that was determined to be in an interruption failure state, as well as the disconnection target ECU, in the memory unit 55.

If the control unit 53 determines in S303 that information about the fault location is stored, it proceeds to S309. In other words, if a stuck-ON fault has already occurred in any of the power supply switching units 31-33 when this processing was last executed, the control unit 53 proceeds to S309.

In S309, the control unit 53 executes switching control for the power supply switching units 31-33. In S310, the control unit 53 determines whether the switching control for the power supply switching unit stored as the fault location was to switch to the OFF state.

If the control unit 53 determines in S310 that the switching control for the power supply switching unit stored as the fault location was not a switching to the OFF state (that is, was to switch to the ON state), it proceeds to S311.

In S311, the communication unit 54 transmits a start frame to the ECU corresponding to the power supply switching unit stored as the fault location. That is, the communication unit 54 instructs the ECU connected to the power supply switching unit in which a stuck-ON fault has occurred to resume the transmission process.

If the control unit 53 determines in S310 that the switching control for the power supply switching unit stored as the fault location was to switch to the OFF state, it proceeds to S312. In S312, the communication unit 54 transmits a stop frame to the ECU corresponding to the power supply switching unit stored as the fault location. That is, the communication unit 54 instructs the ECU connected to the power supply switching unit in which a stuck-ON fault has occurred to stop the transmission process.

In S313, the control unit 53 determines whether a communication frame has been transmitted from the disconnection target ECUs. That is, the control unit 53 determines whether any communication frame has been received from ECUs 1-3 corresponding to the power supply switching units for which switching control to the OFF state was executed in S309. More specifically, the control unit 53 determines whether a communication frame has been received from the disconnection target ECUs corresponding to power supply switching units not yet stored as fault locations. That is, the control unit 53 determines whether a communication frame has been received from an ECU corresponding to a newly failed power supply switching unit that has not yet been stored in the memory unit 55 as a fault location.

If the control unit 53 determines in S313 that no communication frame has been transmitted from the disconnection target ECUs, this switching process is terminated. Not receiving a communication frame from the disconnection target ECUs is normal, and it can be considered that there is no newly failed power supply switching unit.

On the other hand, if the control unit 53 determines in S313 that a communication frame has been transmitted from the disconnection target ECUs, it proceeds to S314 and determines that the power supply switching unit corresponding to the disconnection target ECU is in an interruption failure state. Since a communication frame should not normally be received from the disconnection target ECUs, it can be assumed that there is a newly failed power supply switching unit.

In S315, the communication unit 54 transmits a stop frame to the ECU connected to the newly failed power supply switching unit. In S316, the control unit 53 stores the newly failed power supply switching unit and the ECU connected to the power supply switching unit in the memory unit 55. Thereafter, ECU 5 terminates this switching process.

### 1-2-4. Process When Stopping or Starting Transmission Process

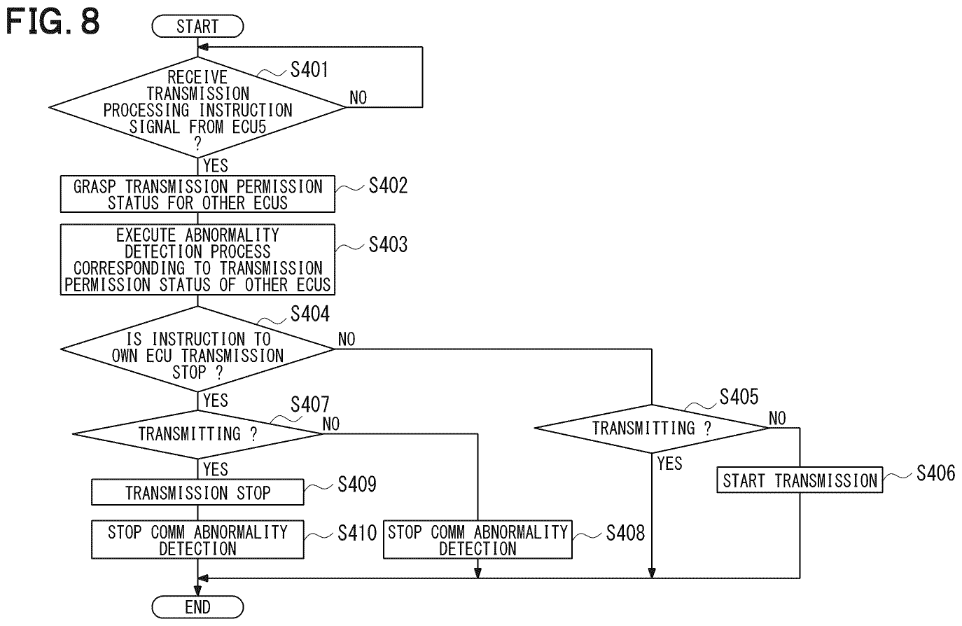

The process by which ECUs 1-3 stop or start the transmission process upon receiving a stop frame or start frame will be explained with reference to the flowchart in FIG. 8. This process is, for example, repeatedly executed while the ignition switch is ON.

In S401, ECUs 1-3 determine whether a transmission process instruction signal has been received from ECU 5. More specifically, ECUs 1-3 determine whether a stop frame or start frame has been received. For example, when ECUs 1-3 receive a communication frame with a predetermined communication ID, they determine that a transmission process instruction signal has been received.

If ECUs 1-3 determine in S401 that a transmission process instruction signal has not been received, the process returns to the beginning of this switching process. On the other hand, if ECUs 1-3 determine that a transmission process instruction signal has been received, the process proceeds to S402.

In S402, ECUs 1-3 check the transmission permission state for other ECUs. More specifically, ECUs 1-3 check whether the bit in the data field corresponding to each ECU 1-3 is “1” (that is, an instruction to stop transmission) or “0” (that is, an instruction to permit transmission).

Subsequently, ECUs 1-3 perform anomaly detection processing corresponding to the transmission permission state of other ECUs. More specifically, if ECUs 1-3 receive any communication frame from an ECU for which an instruction to stop transmission has been given, they do not use the communication frame for anomaly detection processing. Normally, an ECU for which an instruction to stop transmission has been given should not execute the transmission process. Therefore, even if a communication frame is received from an ECU that should not execute the transmission process, ECUs 1-3 disregard the communication frame due to its low reliability. On the other hand, if ECUs 1-3 receive any communication frame from an ECU for which an instruction to permit transmission has been given, they use the communication frame for anomaly detection processing.

In S404, ECUs 1-3 determine whether their own ECU has received an instruction to stop transmission. More specifically, ECUs 1-3 check whether the bit in the data field corresponding to their own ECU is “1” (that is, an instruction to stop transmission) or “0” (that is, an instruction to permit transmission).

If ECUs 1-3 determine in S404 that their own ECU has not received an instruction to stop transmission (i.e., has received an instruction to permit transmission), the process proceeds to S405.

In S405, ECUs 1-3 determine whether the transmission process is ongoing. If ECUs 1-3 determine in S405 that the transmission process is not ongoing (i.e., is stopped), the process proceeds to S406, where the transmission process is started.

On the other hand, if ECUs 1-3 determine in S405 that the transmission process is ongoing, the process is terminated. On the other hand, if ECUs 1-3 determine in S404 that an instruction to stop transmission has been given to their own ECU, the process proceeds to S407.

In S407, ECUs 1-3 determine whether the transmission process is ongoing. If ECUs 1-3 determine in S407 that the transmission process is not ongoing, the process proceeds to S408, and communication anomaly detection is stopped. Communication anomaly detection is, in principle, not executed when power supply is interrupted (in other words, in the sleep state). Furthermore, if communication anomaly detection is executed at a timing when it should not be executed, it may lead to erroneous determination. Therefore, to avoid unnecessary processing, communication anomaly detection is stopped when a stuck-ON fault occurs in the power supply switching unit.

On the other hand, if ECUs 1-3 determine in S407 that the transmission process is ongoing, the process proceeds to S409. In S409, ECUs 1-3 stop the transmission process.

Subsequently, in S410, ECUs 1-3 also stop communication anomaly detection. Thereafter, ECUs 1-3 terminate the process.

### 1-3. Effects

According to the embodiment described in detail above, the following effects can be obtained.

(1a) When the control unit 53 receives a communication frame from ECUs 1-3 corresponding to the power supply switching units 31-33 for which switching control to the OFF state has been executed, it determines that the power supply switching units 31-33 are in an interruption failure state (i.e., have failed to interrupt the power supply). If switching control to transition one power supply switching unit to the OFF state is executed by the control unit 53, and the power supply switching unit is determined to be in an interruption failure state, the communication unit 54 transmits a stop frame to the ECU corresponding to the power supply switching unit. With such a configuration, even if the power supply path is actually not interrupted, ECUs 1-3 can recognize that it is a situation in which the transmission process should be stopped. Therefore, ECUs 1-3 can stop the transmission process just as if the power supply switching units 31-33 were actually switched to the OFF state. Accordingly, even if the power supply to ECUs 1-3 is not interrupted, ECUs 1-3 will cease unnecessary communication.

(1b) If switching control to transition the relevant power supply switching unit to the ON state is executed by the control unit 53, and the power supply switching unit is determined to be in an interruption failure state, the communication unit 54 transmits a start frame to the ECU corresponding to the power supply switching unit. With such a configuration, even if the transmission process is stopped in a situation where a stuck-ON fault has occurred in the power supply switching units 31-33, the transmission process can be resumed. Therefore, at the timing when the transmission process should originally be executed, ECUs 1-3 can appropriately start the transmission process.

(1c) When ECUs 1-3 receive a stop frame, they stop the transmission process and also stop communication anomaly detection by the anomaly detection unit 14. With such a configuration, communication anomaly detection, which should not be executed when the power supply paths 21-23 are interrupted, can be stopped in the same manner as the transmission process. Therefore, like the transmission process, ECUs 1-3 will not perform unnecessary processing. Furthermore, if communication anomaly detection is executed at a timing when it should not be executed, it may lead to erroneous determination. However, since ECUs 1-3 do not perform unnecessary communication anomaly detection, false determination can be suppressed.

Moreover, when ECUs 1-3 receive a start frame, they start the transmission process and also start communication anomaly detection by the anomaly detection unit 14. With such a configuration, even if communication anomaly detection is stopped in a situation where a stuck-ON fault has occurred in the power supply switching units 31-33, communication anomaly detection can be resumed. Therefore, at the timing when communication anomaly detection should normally be executed, ECUs 1-3 can appropriately start communication anomaly detection.

(1d) ECUs 1-5 have a wake-up state and a sleep state. ECUs 1-5 are configured to transition to the sleep state when none of the ECUs 1-5 receives a communication request. If a stuck-ON fault occurs in the power supply switching units 31-33 and ECUs 1-3 cannot stop the transmission process, communication requests will be transmitted, preventing other ECUs constituting the communication system 100 from transitioning to the sleep state. Therefore, the power consumption of the communication system 100 will not be reduced, and battery depletion may occur. However, according to the configuration described above, even if a stuck-ON fault occurs in the power supply switching units 31-33, ECUs 1-3 can stop the transmission process. Therefore, ECUs 1-3 will also stop transmitting communication requests. If all ECUs 1-5 constituting the communication system 100 can stop the transmission process, all ECUs 1-5 will stop transmitting communication requests, and ECUs 1-5 can transition to the sleep state. Accordingly, the power consumption of the communication system 100 can be reduced.

(1e) ECUs 1-3 can receive not only stop frames and start frames addressed to themselves, but also stop frames and start frames addressed to other ECUs. When ECUs 1-3 receive a communication frame from an ECU instructed to stop the transmission process, they do not use the information of the communication frame for communication anomaly detection by the anomaly detection unit 14. On the other hand, when ECUs 1-3 receive a communication frame from an ECU instructed to start the transmission process, they use the information of the communication frame for communication anomaly detection by the anomaly detection unit 14. Here, normally, an ECU instructed to stop the transmission process should not execute the transmission process. Therefore, a communication frame received from an ECU that should not execute the transmission process may have low data reliability. According to the configuration described above, ECUs 1-3 do not use communication frames received from ECUs that should not execute the transmission process for communication anomaly detection, so it is not necessary to use communication frames with low data reliability. Furthermore, using communication frames with low data reliability may lead to false determination, but according to the configuration described above, ECUs 1-3 do not use such communication frames, so false determination can be suppressed.

On the other hand, when ECUs 1-3 receive a communication frame from an ECU instructed to start the transmission process, they use the information in the communication frame for communication anomaly detection and can appropriately execute communication anomaly detection.

### 1-4. Correspondence

ECUs 1-3 correspond to a plurality of communication devices. ECU 5 corresponds to an in-vehicle device.

### 2. Other Embodiments

The embodiments of the present disclosure have been described above; however, it is needless to say that the present disclosure is not limited to the above embodiments and may take various forms.

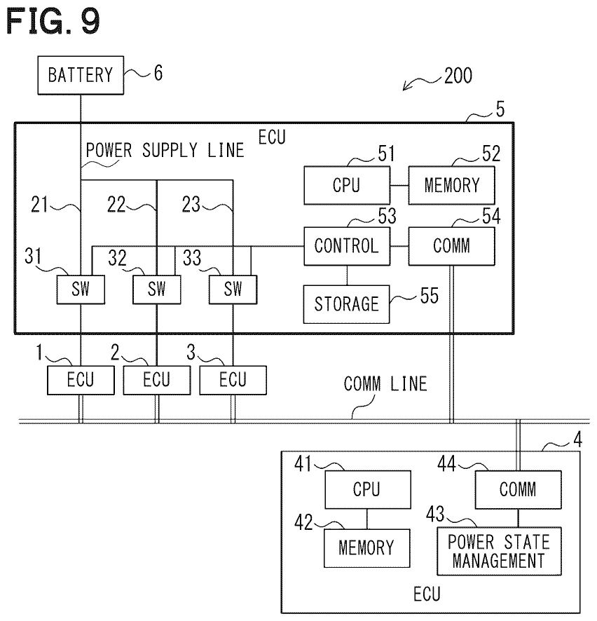

(2a) In the above embodiment, a configuration in which the power supply switching units 31-33 are provided outside ECU 5 was exemplified. However, for example, as shown in the modified example 1 communication system 200 in FIG. 9, the power supply switching units 31-33 may be provided inside ECU 5.

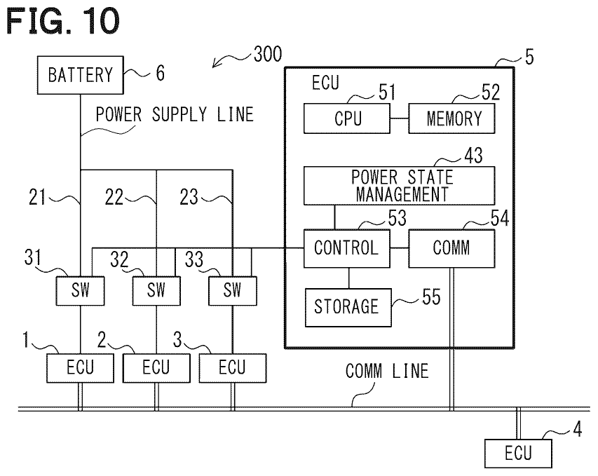

(2b) In the above embodiment, a configuration in which ECU 4 is equipped with the power state management unit 43 was exemplified. However, for example, as shown in the modified example 2 communication system 300 in FIG. 10, the power state management unit 43 may be provided in ECU 5. In other words, the power state management unit 43 and the control unit 53 may be provided in the same ECU. If the power state management unit 43 and the control unit 53 are provided in separate ECUs and communication between those ECUs becomes impossible, the control unit 53 will be unable to acquire management information from the power state management unit 43. However, according to the modified example 2 communication system 300, since the power state management unit 43 and the control unit 53 are provided in the same ECU, the control unit 53 can acquire management information from the power state management unit 43 without communication.

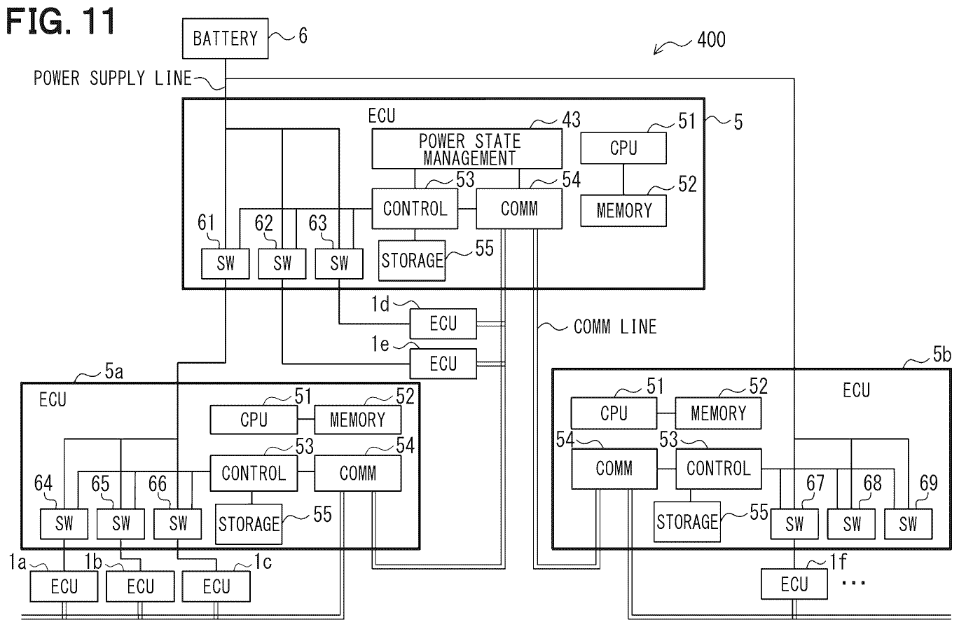

(2c) Furthermore, for example, as shown in the modified example 3 communication system 400 in FIG. 11, ECU 5 may be equipped with both the power supply switching units and the power state management unit 43. Also, the communication system may be equipped with a plurality of ECUs having a control unit 53.

In the communication system 400, the power supply switching units controlled for each control unit 53 differ. As one example, the control unit 53 of ECU 5 controls the power supply switching units 61-63, the control unit 53 of ECU 5a controls the power supply switching units 64-66, and the control unit 53 of ECU 5b controls the power supply switching units 67-69. Whether the power supply switching units 61-69 should transition to the ON state or the OFF state is centrally managed by the power state management unit 43 of ECU 5.

The power supply switching unit 61 is configured to switch between the ON state and the OFF state in each power supply path between the battery 6 and the power supply switching units 64-66. The power supply switching unit 62 is configured to switch between the ON state and the OFF state in the power supply path between the battery 6 and ECU 1e. The power supply switching unit 63 is configured to switch between the ON state and the OFF state in the power supply path between the battery 6 and ECU 1d.

The power supply switching unit 64 is configured to switch between the ON state and the OFF state in the power supply path between the battery 6 and ECU 1a. The power supply switching unit 65 is configured to switch between the ON state and the OFF state in the power supply path between the battery 6 and ECU 1b. The power supply switching unit 66 is configured to switch between the ON state and the OFF state in the power supply path between the battery 6 and ECU 1c.

The power supply switching unit 67 is configured to switch between the ON state and the OFF state in the power supply path between the battery 6 and ECU 1f. The ECUs corresponding to the power supply switching units 68 and 69 are omitted from the illustration.

(2d) Each device described in the present disclosure (i.e., ECUs 1-5) and the methods performed by each device may be implemented by a dedicated computer provided by configuring a processor and memory programmed to execute one or more functions embodied as a computer program. Alternatively, each device and method described in the present disclosure may be implemented by a dedicated computer provided by configuring a processor with one or more dedicated hardware logic circuits. Or, each device and method described in the present disclosure may be implemented by one or more dedicated computers configured by a combination of a processor and memory programmed to execute one or more functions and a processor configured with one or more hardware logic circuits. Furthermore, the computer program may be stored as instructions executable by a computer on a computer-readable non-transitory tangible recording medium. The method for realizing the functions of each unit included in each device does not necessarily have to include software, and all functions may be implemented using one or more hardware components.

(2e) The function of one component in the above embodiment may be distributed among a plurality of components, or the functions of a plurality of components may be integrated into one component. Also, part of the configuration of the above embodiment may be omitted. Furthermore, at least part of the configuration of the above embodiment may be added to, replaced with, or otherwise modified with respect to the configuration of another embodiment described above.

(2f) The present disclosure may be realized in various forms, such as the aforementioned in-vehicle device, a system including the in-vehicle device as a component, a program for causing a computer to function as the in-vehicle device, a medium recording the program, a method for switching process, and so on.

What is claimed is:

1. An in-vehicle device used in an in-vehicle system in which a plurality of communication devices are installed, wherein each of the plurality of communication devices is configured to receive power supply via each power supply path, and each of the power supply paths is provided with a power supply switching unit configured to switch between an ON state in which the respective power supply path is conducted and an OFF state in which the respective power supply path is interrupted, the in-vehicle device comprising
at least one of (i) a circuit and (ii) a processor with a memory storing computer program code executable by the processor, the at least one of the circuit and the processor configured to cause the in-vehicle device to:
execute switching control to switch the power supply switching unit to either the ON state or the OFF state; and
communicate with the plurality of communication devices,
wherein
for each of the power supply switching units, when the in-vehicle device receives a communication frame from a communication device corresponding to the power supply switching unit for which switching control to the OFF state has been executed, the in-vehicle device determines that the power supply switching unit is in an interruption failure state in which the power supply switching unit cannot transition to the OFF state, and
when switching control to transition one of the power supply switching units to the OFF state is executed, and when the one of the power supply switching units is determined to be in the interruption failure state, the in-vehicle device transmits a stop frame, which is a communication frame instructing the communication device corresponding to the one of the power supply switching units to stop a transmission process for transmitting a communication frame.

2. The in-vehicle device according to claim 1, wherein
when switching control to transition the one of the power supply switching units to the ON state is executed, and when the one of the power supply switching units is determined to be in the interruption failure state, the in-vehicle device transmits a start frame, which is a communication frame instructing the communication device corresponding to the one of the power supply switching units to start the transmission process.

3. The in-vehicle device according to claim 1, wherein
the at least one of the circuit and the processor is further configured to manage whether the power supply switching unit should transition to the ON state or the OFF state according to a running state of a vehicle, and to notify management information indicating whether the power supply switching unit should transition to the ON state or the OFF state,
wherein
the in-vehicle device executes switching control in accordance with the management information notified.

4. The in-vehicle device according to claim 2, wherein
the plurality of communication devices include
an anomaly detection unit configured to execute communication anomaly detection to detect whether there is an abnormality in a communication state of the in-vehicle system,
the communication device corresponding to the one of the power supply switching units, upon receiving the stop frame, stops the transmission process and also stops communication anomaly detection by the anomaly detection unit, and
the communication device corresponding to the one of the power supply switching units, upon receiving the start frame, starts the transmission process and also starts communication anomaly detection by the anomaly detection unit.

5. The in-vehicle device according to claim 1, wherein
the plurality of communication devices and the in-vehicle device have a wake-up state as a normal operating state and a sleep state as a low power consumption operating state in which at least part of functions is restricted, and
the plurality of communication devices and the in-vehicle device are configured to transition to the sleep state when no communication request is received by any of the plurality of communication devices or the in-vehicle device.

6. The in-vehicle device according to claim 2, wherein
the plurality of communication devices include an anomaly detection unit configured to execute communication anomaly detection to detect whether there is an abnormality in a communication state of the in-vehicle system,
the plurality of communication devices are configured to receive, in addition to the stop frame and the start frame addressed to themselves, the stop frame and the start frame addressed to other communication devices,
when a communication frame is received from a communication device instructed to stop the transmission process, the plurality of communication devices do not use the information of the communication frame in communication anomaly detection by the anomaly detection unit, and
when a communication frame is received from a communication device instructed to start the transmission process, the plurality of communication devices use the information of the communication frame in communication anomaly detection by the anomaly detection unit.

7. An in-vehicle system comprising
a plurality of communication devices; and
an in-vehicle device,
wherein
each of the plurality of communication devices is configured to receive power supply via a respective power supply path,
each of the power supply paths is provided with a power supply switching unit configured to switch between an ON state in which the respective power supply path is conducted and an OFF state in which the respective power supply path is interrupted,
the in-vehicle device includes:
a control unit configured to execute switching control to switch each of the power supply switching units to either the ON state or the OFF state; and
a communication unit configured to communicate with the plurality of communication devices;
for each of the power supply switching units, when the control unit receives a communication frame from a communication device corresponding to a power supply switching unit for which switching control to the OFF state has been executed, the control unit determines that the power supply switching unit is in an interruption failure state in which the power supply switching unit cannot transition to the OFF state; and
when switching control to transition one of the power supply switching units to the OFF state is executed by the control unit, and when the one of the power supply switching units is determined to be in the interruption failure state by the control unit,
the communication unit transmits a stop frame, which is a communication frame instructing the communication device corresponding to the one of the power supply switching units to stop the transmission process for transmitting a communication frame.
